(19) United States
(12) Patent Application Publication
(10) Pub. No.: US 2006/0081145 A1
(43) Pub. Date: Apr. 20, 2006

(54) Image forming apparatus having function of measuring moment of inertia and friction coefficient and method of measuring the same

(75) Inventors: Tae-young Kim, Suwon-si (KR); Sung-ryul Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/226,407

(22) Filed: Sep. 15, 2005

(30) Foreign Application Priority Data
Oct. 18, 2004 (KR) 10-2004-0083232

(51) Int. Cl. B41F 33/16; B41J 29/393

(52) U.S. Cl. 101/484; 347/13; 347/5

(57) ABSTRACT

An image forming apparatus and method are provided for measuring a moment of inertia and friction coefficient in the image forming apparatus. The image forming apparatus includes a printing unit for printing an image on a medium, and a parameter calculating unit for measuring at least one of a current and velocity of a driving motor and calculating at least one of a moment of inertia and friction coefficient of the image forming apparatus. Accordingly, the image forming apparatus can measure the moment of inertia and friction coefficient of the image forming apparatus without a separate measuring apparatus, and it is possible to inspect an assembled image forming apparatus and parts therein to maintain the image forming apparatus in an optimal printing state.

### CROSS-REFERENCE TO RELATED APPLICATIONS

This application claims the benefit under 35 U.S.C. §119(a) of Korean Patent Application No. 10-2004-0083232, filed in the Korean Intellectual Property Office on Oct. 18, 2004, the entire disclosure of which is incorporated herein by reference.

### BACKGROUND OF THE INVENTION

1. Field of the Invention

The present invention relates to an image forming apparatus. More particularly, the present invention relates to an image forming apparatus having a function and method of measuring a moment of inertia and friction coefficient in the image forming apparatus.

2. Description of Related Art

In general, image forming apparatuses perform functions of converting documents edited using applications and images picked up by digital cameras, into coded data and outputting the coded data as a visible form on a medium.

In mass production of the image forming apparatuses, abnormal image forming apparatuses, of which friction coefficients are beyond a normal value, may be produced due to abnormal states of parts or assembly. Therefore, it is necessary to measure moments of inertia and friction coefficients of the image forming apparatuses in order to inspect the image forming apparatuses. In addition, it is necessary to measure moments of inertia and friction coefficients of the image forming apparatuses in order to confirm proper parts or assembling methods of the apparatus.

In general, the measurement of the moments of inertia and friction coefficients of the image forming apparatuses is carried out by printing test patterns on a medium with the associated image forming apparatus, and determining any abnormality of operations associated with the moment of inertia and friction coefficient by inspecting the printed patterns with the naked eye. The measurement of the moments of inertia and friction coefficients can also be carried out by using a separate measuring apparatus.

FIG. 1 is a block diagram showing a conventional measuring apparatus for measuring a moment of inertia and friction coefficient of an image forming apparatus 100. The measuring apparatus comprises a test jig box 110, an oscilloscope 120, and a personal computer (PC) 130.

The test jig box 110 applies a voltage to the image forming apparatus 100 to operate with a constant velocity and measures the resulting velocity of the image forming apparatus 100. The oscilloscope 120 measures a current of a motor (not shown) driving the image forming apparatus 100. The PC 130 calculates the moment of inertia and friction coefficient based on the velocity and current measurements received from the test jig box 110 and the oscilloscope 120.

However, in the conventional measuring apparatus, there is a problem in that a large amount of ink, medium, and time are consumed. In addition, an abnormality of the image forming apparatus cannot always be accurately detected by inspecting the printed pattern with the naked eye. In that case, an additional measuring apparatus must be separately provided.

Accordingly, a need exists for a system and method for effectively and efficiently measuring a moment of inertia and friction coefficient in an image forming apparatus.

### SUMMARY OF THE INVENTION

Embodiments of the present invention substantially solve the above and other problems, and provide an image forming apparatus having a function of measuring a moment of inertia and friction coefficient in the image forming apparatus.

Embodiments of the present invention further provide a method of measuring a moment of inertia and friction coefficient in an image forming apparatus.

According to an aspect of the present invention, an image forming apparatus is provided for printing an image by using a motor as a driving source, comprising a printing unit for printing an image on a medium, and a parameter calculating unit for measuring at least one of a current and velocity of the motor and calculating at least one of a moment of inertia and friction coefficient of the image forming apparatus using the measured value.

The image forming apparatus may be driven using a DC motor as a power source through a belt and a gear.

The parameter calculating unit may comprise a power supplying unit for supplying power to the motor, a current measuring unit for measuring the current of the motor at the time when the motor starts to operate while increasing power supplied to the motor, and a first calculating unit for calculating a kinetic friction coefficient of the motor using the measured current.

The parameter calculating unit may further comprise a constant velocity control unit for controlling a motor to operate with a constant velocity, a state measuring unit for measuring a velocity and a current of the motor, and a second calculating unit for calculating a viscous friction coefficient of the motor using the measured velocity and current of the motor.

The parameter calculating unit may still further comprise a constant velocity control unit for controlling a motor to operate with a constant velocity, a state measuring unit for measuring a velocity and a current of the motor, and a third calculating unit for calculating a coulomb friction coefficient of the motor using the measured velocity and current of the motor.

The parameter calculating unit may still further comprise a voltage applying unit for applying a rated voltage of the motor, a velocity measuring unit for measuring a velocity of the motor, a time constant measuring unit for measuring a time constant of the motor by using the measured velocity of the motor, and a fourth calculating unit for calculating the moment of inertia of the image forming apparatus using the measured time constant.

The image forming apparatus may further comprise a user input unit for generating a signal for starting the parameter calculating unit in response to a user's request for measuring a parameter.

The image forming apparatus may still further comprise a display unit for displaying at least one of the calculated moment of inertia and friction coefficient of the image forming apparatus.

The image forming apparatus may still further comprise a control unit for adjusting a voltage applied to the motor by using at least one of the calculated moment of inertia and friction coefficient of the image forming apparatus.

The image forming apparatus may still further comprise an encoder for generating an electrical signal corresponding to the operational state of the motor, and a sensing unit for sensing an operational limit point of the printing unit by using the signal generated by the encoder and generating a signal used to stop the printing unit when the operational state reaches the operational limit point.

According to another aspect of the present invention, an image forming apparatus is provided for printing an image by using a motor as a driving source, comprising a printing unit for printing an image on a medium, a parameter calculating unit for measuring at least one of a current and velocity of the motor and calculating at least one of a moment of inertia and friction coefficient of the image forming apparatus, and a measurement signal generating unit for generating a signal for starting the parameter calculating unit.

The measurement signal generating unit may comprise a memory for storing the number of pages printed by the printing unit, a memory controller for controlling the memory to store the number of pages printed by the printing unit, and a signal generating unit for generating a signal for starting the parameter generating unit when the number of printed pages stored in the memory reaches a predetermined value.

The image forming apparatus may further comprise a display unit for displaying at least one of the calculated moment of inertia and friction coefficient of the image forming apparatus.

The image forming apparatus may further comprise a control unit for adjusting a voltage applied to the motor by using at least one of the calculated moment of inertia and friction coefficient of the image forming apparatus.

According to another aspect of the present invention, a method is provided for measuring a parameter of an image forming apparatus, comprising receiving a command for measuring a parameter of a motor driving the image forming apparatus from a user, measuring at least one of a current and velocity of the motor, calculating at least one of a moment of inertia and friction coefficient of the image forming apparatus by using at least one of the measured current and velocity, and displaying at least one of the calculated moment of inertia and friction coefficient of the image forming apparatus.

The method may further comprise a step for adjusting a voltage applied to the motor by using at least one of the calculated moment of inertia and friction coefficient of the image forming apparatus.

According to another aspect of the present invention, a method is provided for measuring a parameter of an image forming apparatus, comprising measuring at least one of a current and velocity of a motor driving the image forming apparatus after a predetermined time interval, calculating at least one of a moment of inertia and friction coefficient of the image forming apparatus by using at least one of the measured current and velocity, and adjusting a velocity applied to the motor by using at least one of the calculated moment of inertia and friction coefficient of the image forming apparatus.

At least one of the current and velocity of the motor driving the image forming apparatus may be measured when the number of printed pages reaches a predetermined value.

According to another aspect of the present invention, a computer-readable medium is provided having embodied thereon a computer program for executing a method of measuring a parameter of an image forming apparatus.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram showing a conventional measuring apparatus for measuring a moment of inertia and friction coefficient of an image forming apparatus;

FIG. 2 is a block diagram showing an image forming apparatus having a function of measuring a moment of inertia and friction coefficient according to an embodiment of the present invention;

FIG. 3 is a block diagram showing a model of an image forming apparatus using a DC motor as a driving source according to an embodiment of the present invention;

FIG. 4 is a detailed block diagram showing an embodiment of a parameter calculating unit of FIG. 2 according to an embodiment of the present invention;

FIG. 5 is a detailed block diagram showing another embodiment of a parameter calculating unit of FIG. 2 according to an embodiment of the present invention;

FIG. 6 is a graph for illustrating a method of calculating a viscous friction coefficient and a coulomb friction force according to an embodiment of the present invention;

FIG. 7 is a detailed block diagram showing another embodiment of a parameter calculating unit of FIG. 2 according to an embodiment of the present invention;

FIG. 8 is a block diagram showing an image forming apparatus having a function of automatically measuring parameters according to an embodiment of the present invention;

FIG. 9 is a detailed block diagram showing an embodiment of a measurement signal generating unit of FIG. 8 according to an embodiment of the present invention;

FIG. 10 is a flowchart showing a method of measuring a moment of inertia and friction coefficient according to an embodiment of the present invention;

FIG. 11 is a flowchart showing a method of calculating a static friction force according to an embodiment of the present invention;

FIG. 12 is a flowchart showing a method of calculating a viscous friction coefficient and a coulomb friction force according to an embodiment of the present invention;

FIG. 13 is a flowchart showing a method of calculating a moment of inertia according to an embodiment of the present invention; and

FIG. 14 is a flowchart showing a method of automatically measuring parameters of an image forming apparatus according to an embodiment of the present invention.

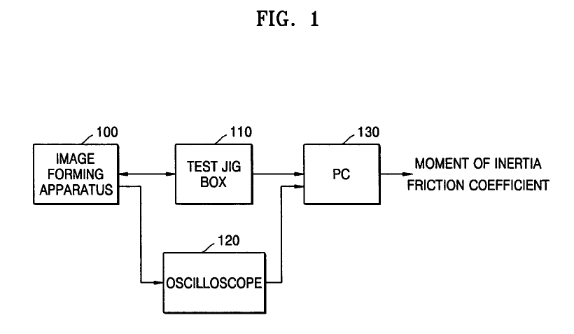

Throughout the drawings, like reference numerals will be understood to refer to like parts, components and structures.

### DETAILED DESCRIPTION OF THE EXEMPLARY EMBODIMENTS

An image forming apparatus having a function of measuring a moment of inertia and friction coefficient in the image forming apparatus, and a method of measuring a moment of inertia and friction coefficient in an image forming apparatus according to embodiments of the present invention, will now be described in detail with reference to the accompanying drawings.

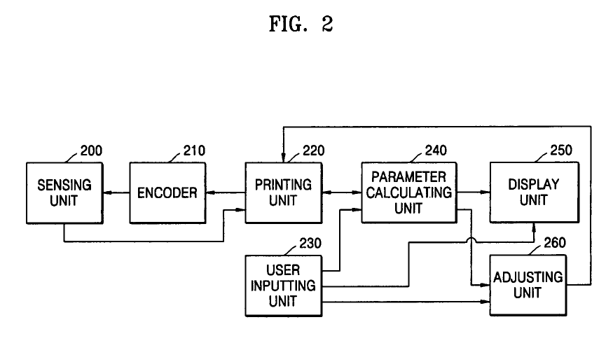

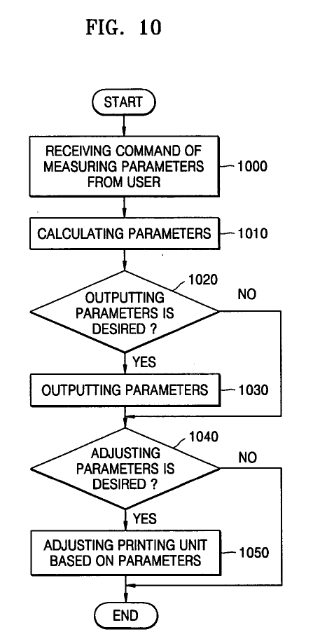

FIG. 2 is a block diagram showing an image forming apparatus having a function of measuring a moment of inertia and friction coefficient according to an embodiment of the present invention. The image forming apparatus comprises a sensing unit 200, an encoder 210, a printing unit 220, a user inputting unit 230, a parameter calculating unit 240, a display unit 250, and an adjusting unit 260. Operations of the image forming apparatus will now be described with reference to a flowchart of a method of measuring a moment of inertia and friction coefficient as shown in FIG. 10.

The image forming apparatus is driven using a DC motor (not shown) as a power source through a power transmission device such as a belt and a gear (not shown). The user inputting unit 230 receives a command for measuring a moment of inertia and friction coefficient of the image forming apparatus from a user, and generates a measurement signal for starting the parameter calculating unit 240 at step (S1000). In response to the measurement signal of the user inputting unit 230, the parameter calculating unit 240 calculates parameters, such as the moment of inertia and the friction coefficient, at step (S1010).

The display unit 250 determines whether or not the user desires to display the calculated parameters on a screen of the display unit 250 at step (S1020). If the user desires to display the calculated parameters, the display unit 250 displays the calculated parameters at step (S1030). Preferably, the calculated parameters may be printed on a medium (not shown) by the printing unit 220.

The adjusting unit 260 determines whether or not the user desires to adjust the operation of the printing unit 220 based on the calculated parameters at step (S1040). If the user desires to adjust the operation of the printing unit 220, the adjusting unit 260 adjusts the printing unit 220 by controlling the voltage applied to the motor of the printing unit 220 based on the calculated parameters at step (S1050).

The encoder 210 generates an electrical signal corresponding to the operational state of the motor of the printing unit 220. The sensing unit 200 determines whether or not the printing unit 220 of the image forming apparatus is in a critical state of operation. If the printing unit 220 is in a critical state of operation, the sensing unit 200 preferably generates a control signal for stopping the printing unit 220.

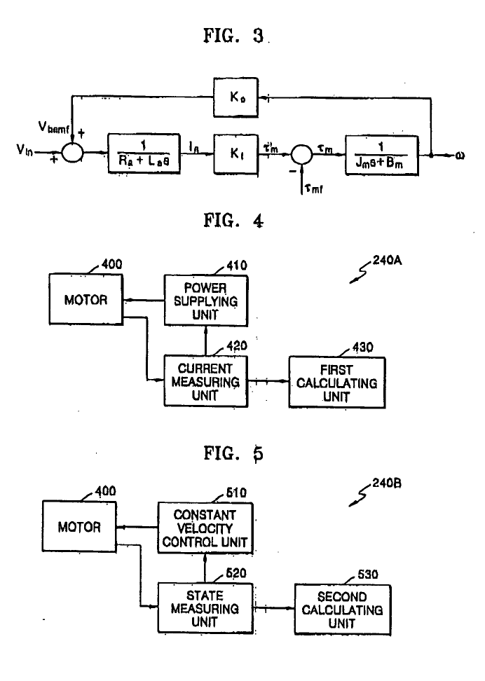

FIG. 3 is a block diagram showing a model of an image forming apparatus using a DC motor as a driving source. In FIG. 3, V_{bemf} is a back EMF voltage, Rₐ is an armature resistance, Lₐ is an armature inductance, iₐ is an armature current, Kₜ is a torque constant of the motor, Kₑ is a back EMF constant, τₘ is a torque of the motor, τ_{mf} is a friction torque, Bₘ is a viscous friction coefficient, Jₘ is a moment of inertia, and ωₘ is an angular velocity.

The image forming apparatus is represented by Equation (1) below.
Kₜ×iₐ=Jₘ×\dot{ω}ₘ+Bₘ×ωₘ+τ_{mf} (1)

If, as an example, Lₐ=0, an input/output transfer function of the image forming apparatus is represented by Equation (2) below.

$$G ( s ) = \frac{Ω ( s )}{Vin ( s )} = \frac{\frac{{K}_{t}}{{R}_{a}}}{{J}_{m} \cdot s + {B}_{m} + \frac{{K}_{t} \cdot {K}_{e}}{{R}_{a}}} \qquad ( 2 )$$

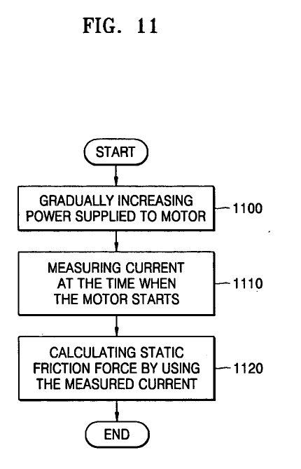

FIG. 4 is a detailed block diagram showing an embodiment of a parameter calculating unit of FIG. 2. The parameter calculating unit 240A comprises a current measuring unit 420 and a first calculating unit 430. Operations of the parameter calculating unit 240A will now be described with reference to a flowchart showing a method of calculating a static friction force τ_{mfs} of FIG. 11.

A power supplying unit 410 supplies power to the motor 400. Under the control of the current measuring unit 420, the power supplying unit 410 gradually increases the power supplied to the motor 400 from a power of approximately 0 at step (S1100). The current measuring unit 420 measures a current Iₛₜ of the motor 400 at the time when the motor 400 starts at step (S110).

The first calculating unit 430 calculates the static friction force τ_{mfs} by using the measured current Iₛₜ of the motor at step (S1120). The static friction force τ_{mfs} is a friction force of the image forming apparatus at the time when the motor 400 starts (ωₘ=0 rad/s). By using Equation (1) and ωₘ=0 rad/s, the static friction force τ_{mfs} is represented by Equation (3) below.
τ_{mfs}=Iₛₜ·Kₜ (3)

When the image forming apparatus is detected to be in a critical state by the sensing unit 200, the image forming apparatus preferably stops.

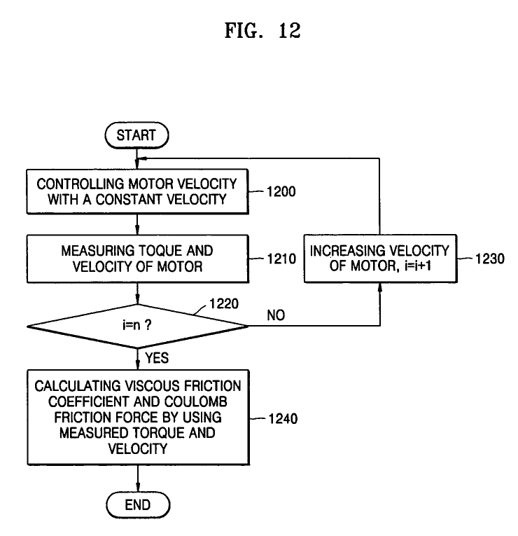

FIG. 5 is a detailed block diagram showing another embodiment of a parameter calculating unit of FIG. 2. The parameter calculating unit 240B comprises a constant velocity control unit 510, a state measuring unit 520, and a second calculating unit 530. Operations of the parameter calculating unit 240B will now be described with reference to a flowchart showing a method of calculating a viscous friction coefficient Bₘ and a coulomb friction force τ_{mfc} of FIG. 12.

The constant velocity control unit 510 controls the motor 400 to operate with a constant velocity v at step (S1200). The state measuring unit 520 measures a torque τₘ (=Kₜ·Iₐ) and an angular velocity ωₘ at step (S1210).

The operations of steps (S1200) and (S1210) are repeated a predetermined number of times at step (S1220) while the velocity v is increased at step (S1230). The constant velocity control unit 510 supplies the power to the motor 400. The second calculating unit 530 calculates the viscous friction coefficient Bₘ and the coulomb friction force τ_{mfc} by using the torque τₘ and the angular velocity ωₘ of the motor 400 measured using the aforementioned operations at step (S1240). Since the motor 400 operates with a constant velocity, a differential value of the angular velocity ωₘ is 0 in Equation (1). Therefore, the viscous friction coefficient Bₘ and the coulomb friction force τ_{mfc} have a relation represented by Equation (4) below.
Kₜ·iₐ=Bₘ·ωₘ+τ_{mfc} (4)

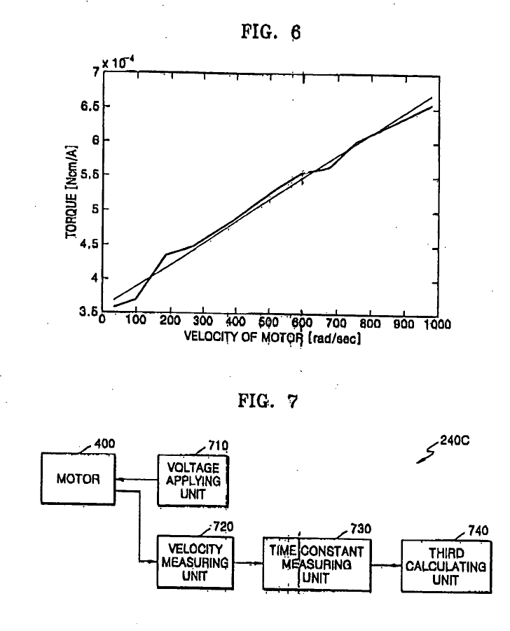

The viscous friction coefficient Bₘ and the coulomb friction force τ_{mfc} are calculated by using the measured torque τₘ and angular velocity ωₘ of the motor 400. Preferably, a curve fitting method may be used. In the curve fitting method, coefficients of an n-th order equation passing several points in a graph are obtained. An exemplary curve fitting method will now be described with reference to FIG. 6.

FIG. 6 is a graph for illustrating a method of calculating the viscous friction coefficient Bₘ and the coulomb friction force τ_{mfc}. In the graph of FIG. 6, the measured viscous friction coefficient Bₘ and the coulomb friction force τ_{mfc} are depicted with respect to 10 constant velocities of from 100 rad/s to 1000 rad/s. The curve of Equation (4) is fitted to a straight line of a linear equation of the torque τₘ and angular velocity ωₘ of the motor 400. Next, by using coefficients of the linear equation, the viscous friction coefficient Bₘ and the coulomb friction force τ_{mfc} can be calculated.

When the image forming apparatus is detected to be in a critical state by the sensing unit 200, the image forming apparatus preferably stops.

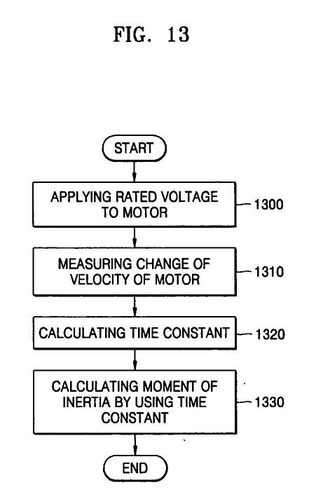

FIG. 7 is a detailed block diagram showing another embodiment of a parameter calculating unit of FIG. 2. The parameter calculating unit 240C comprises a voltage applying unit 710, a velocity measuring unit 720, a time constant measuring unit 730, and a third calculating unit 740. Operations of the parameter calculating unit 240C will now be described with reference to a flowchart showing a method of calculating a moment of inertia Jₘ of FIG. 13.

The voltage applying unit 710 applies a rated voltage Vdc to the motor 400 at step (S1300). The velocity measuring unit 720 measures the angular velocity ωₘ of the motor 400 depending on the rating voltage Vdc at step (S1310). The time constant measuring unit 730 receives the change of the angular velocity ωₘ of the motor 400 and measures a time constant Tₘ which is a time at which the angular velocity ωₘ of the motor 400 is reduced to about 63.2% of a normal state angular velocity at step (S1320).

The third calculating unit 740 calculates the moment of inertia Jₘ by using the time constant Tₘ output from the time constant measuring unit 730 at step (S1330). The time constant Tₘ is a reciprocal of a pole of a transfer function of a system. The time constant Tₘ is calculated by the transfer function of FIG. 2. As a result, the time constant Tₘ can be represented by Equation (5) below.

$${T}_{m} = \frac{{J}_{m}}{{B}_{m} + \frac{{K}_{t} \cdot {K}_{e}}{{R}_{a}}} \qquad ( 5 )$$

By inputting values of the torque constant Kₜ, the back EMF constant Kₑ, the armature resistance Rₐ, and the viscous friction coefficient Bₘ, the moment of inertia Jₘ can be obtained.

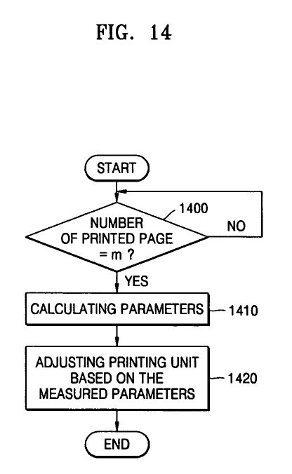

FIG. 8 is a block diagram showing an image forming apparatus having a function of automatically measuring parameters according to an embodiment of the present invention. The image forming apparatus of FIG. 8 comprises the parameter calculating unit 240, the adjusting unit 260, and a measurement signal generating unit 800. Operations of the image forming apparatus shown in FIG. 8 will now be described with reference to a flowchart of a method of automatically measuring parameters of the image forming apparatus shown in FIG. 14.

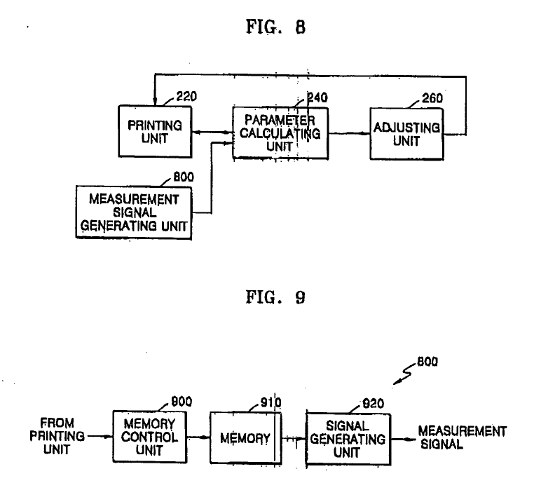

The measurement signal generating unit 800 generates a measurement signal for starting the parameter calculating unit 240 after a predetermined time interval. FIG. 9 is a detailed block diagram showing an embodiment of the measurement signal generating unit 800 according to an embodiment of the present invention. The measurement signal generating unit 800 comprises a memory control unit 900, a memory 910, and a signal generating unit 920.

The memory control unit 900 stores the number of printed pages when the image forming apparatus prints an image and determines whether or not the stored number of printed pages is equal to a predetermined value. If the stored number of printed pages is equal to the predetermined value, the signal generating unit 920 generates the measurement signal for starting the parameter calculating unit 240 at step (S1400).

In response to the measurement signal of the measurement signal generating unit 800, the parameter calculating unit 240 measures the moment of inertia and friction coefficient of the image forming apparatus at step (S1410). The adjusting unit 260 adjusts the printing unit 220 by controlling the voltage applied to the motor 400 of the printing unit 220 based on the calculated parameters at step (S1420).

Preferably, the operations of steps (S1410) and (S1420) may be automatically performed after the image forming apparatus is assembled.

Accordingly, the image forming apparatus can measure the moment of inertia and friction coefficient of the image forming apparatus without a separate measuring apparatus, and it is possible to inspect an assembled image forming apparatus and automatically inspect parts therein. Therefore, it is possible to easily maintain the image forming apparatus in an optimal printing state.

Embodiments of the present invention can also be embodied as computer readable codes on a computer readable recording medium. The computer readable recording medium can be comprised of any data storage device that can store data which can be read by a computer system. Examples of such computer readable recording medium include read-only memory (ROM), random-access memory (RAM), CD-ROM, magnetic tape, floppy disk, optical data storage device, and carrier wave (such as data transmission through the Internet). The computer readable recording medium can also be distributed over network coupled computer systems such that the computer readable code can be stored and executed in a distributed fashion. Also, functional programs, codes, and code segments for accomplishing embodiments of the present invention can be easily construed by programmers skilled in the art.

While the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only and not for purposes of limitation. Therefore, the scope of the invention is defined not by the detailed description of the invention, but by the appended claims, and all differences within the scope will be construed as being included in the present invention.

What is claimed is:

1. An image forming apparatus for printing an image by using a motor as a driving source, comprising:
a printing unit for printing an image on a medium; and
a parameter calculating unit for measuring at least one of a current and a velocity of the motor, and for calculating at least one of a moment of inertia and a friction coefficient of the image forming apparatus using the measured value.

2. The image forming apparatus according to claim 1, wherein the parameter calculating unit comprises:
a current measuring unit for measuring the current of the motor at a time when the motor starts to operate; and
a first calculating unit for calculating a kinetic friction coefficient of the motor using the measured current.

3. The image forming apparatus according to claim 1, wherein the parameter calculating unit comprises:
a constant velocity control unit for controlling the motor to operate with a constant velocity;
a state measuring unit for measuring a velocity and a current of the motor; and
a second calculating unit for calculating a viscous friction coefficient of the motor using the measured velocity and current of the motor.

4. The image forming apparatus according to claim 1, wherein the parameter calculating unit comprises:
a constant velocity control unit for controlling the motor to operate with a constant velocity;
a state measuring unit for measuring a velocity and a current of the motor; and
a third calculating unit for calculating a coulomb friction coefficient of the motor using the measured velocity and current of the motor.

5. The image forming apparatus according to claim 1, wherein the parameter calculating unit comprises:
a voltage applying unit for applying a rated voltage to the motor;
a velocity measuring unit for measuring a velocity of the motor;
a time constant measuring unit for measuring a time constant of the motor by using the measured velocity of the motor; and
a fourth calculating unit for calculating the moment of inertia of the image forming apparatus using the measured time constant.

6. The image forming apparatus according to claim 1, further comprising:
a user input unit for generating a signal for starting the parameter calculating unit in response to a user's request for measuring a parameter.

7. The image forming apparatus according to claim 1, further comprising:
a display unit for displaying at least one of the calculated moment of inertia and friction coefficient of the image forming apparatus.

8. The image forming apparatus according to claim 1, further comprising:
a control unit for adjusting a voltage applied to the motor by using at least one of the calculated moment of inertia and friction coefficient of the image forming apparatus.

9. The image forming apparatus according to claim 1, further comprising:
an encoder for generating an electrical signal corresponding to an operational state of the motor; and
a sensing unit for sensing an operational limit point of the printing unit by using the signal generated by the encoder and generating a signal to stop the printing unit when the operational state reaches the operational limit point.

10. An image forming apparatus for printing an image by using a motor as a driving source, comprising:
a printing unit for printing an image on a medium;
a parameter calculating unit for measuring at least one of a current and velocity of the motor, and for calculating at least one of a moment of inertia and a friction coefficient of the image forming apparatus; and
a measurement signal generating unit for generating a signal for starting the parameter calculating unit.

11. The image forming apparatus according to claim 10, wherein the measurement signal generating unit comprises:
a memory for storing a number of pages printed by the printing unit;
a memory controller for controlling the memory to store the number of pages printed by the printing unit; and
a signal generating unit for generating a signal for starting the parameter generating unit when the number of printed pages stored in the memory reaches a predetermined value.

12. The image forming apparatus according to claim 10, further comprising:
a display unit for displaying at least one of the calculated moment of inertia and friction coefficient of the image forming apparatus.

13. The image forming apparatus according to claim 10, further comprising:
a control unit for adjusting a voltage applied to the motor by using at least one of the calculated moment of inertia and friction coefficient of the image forming apparatus.

14. A method of measuring a parameter of an image forming apparatus, comprising the steps of:
receiving a command for measuring a parameter of a motor driving the image forming apparatus from a user;
measuring at least one of a current and velocity of the motor;
calculating at least one of a moment of inertia and a friction coefficient of the image forming apparatus by using at least one of the measured current and velocity; and
displaying at least one of the calculated moment of inertia and friction coefficient of the image forming apparatus.

15. The method of measuring a parameter according to claim 14, further comprising the step of:
adjusting a voltage applied to the motor by using at least one of the calculated moment of inertia and friction coefficient of the image forming apparatus.

16. A method of measuring a parameter of an image forming apparatus, comprising the steps of:
measuring at least one of a current and velocity of a motor driving the image forming apparatus after a predetermined time interval;
calculating at least one of a moment of inertia and friction coefficient of the image forming apparatus by using at least one of the measured current and velocity; and
adjusting a velocity applied to the motor by using at least one of the calculated moment of inertia and friction coefficient of the image forming apparatus.

17. The method according to claim 16, wherein at least one of the current and velocity of the motor driving the image forming apparatus is measured when the number of printed pages reaches a predetermined value.

18. A computer-readable medium having embodied thereon a computer program for measuring a parameter of an image forming apparatus, comprising:
a first set of instructions for receiving a command for measuring a parameter of a motor driving the image forming apparatus from a user;
a second set of instructions for measuring at least one of a current and velocity of the motor;
a third set of instructions for calculating at least one of a moment of inertia and a friction coefficient of the image forming apparatus by using at least one of the measured current and velocity; and
a fourth set of instructions for displaying at least one of the calculated moment of inertia and friction coefficient of the image forming apparatus.

19. A computer-readable medium having embodied thereon a computer program for measuring a parameter of an image forming apparatus, comprising:
a first set of instructions for measuring at least one of a current and velocity of a motor driving the image forming apparatus after a predetermined time interval;
a second set of instructions for calculating at least one of a moment of inertia and friction coefficient of the image forming apparatus by using at least one of the measured current and velocity; and
a third set of instructions for adjusting a velocity applied to the motor by using at least one of the calculated moment of inertia and friction coefficient of the image forming apparatus.
